(19) United States
(12) Patent Application Publication
(10) Pub. No.: US 2012/0191357 A1
(43) Pub. Date: Jul. 26, 2012

(54) Discovering Progression and Differentiation Hierarchy From Multidimensional Data

(75) Inventors: Peng Qiu, Houston, TX (US); Andrew Gentles, Menlo Park, CA (US); Sylvia Plevritis, Palo ALto, CA (US)

(73) Assignee: The Board of Trustees of the Leland Stanford Junior University, Palo Alto, CA (US)

(21) Appl. No.: 13/338,237

(22) Filed: Dec. 27, 2011

Related U.S. Application Data
(60) Provisional application No. 61/427,467, filed on Dec. 27, 2010.
(60) Provisional application No. 61/449,557, filed on Mar. 4, 2011.

(51) Int. Cl. G06F 19/18; G06F 15/00; G06F 19/00

(52) U.S. Cl. 702/19; 702/127

(57) ABSTRACT

Methods and systems for determining progression and other characteristics of microarray expression levels and similar information, alternatively using a network or communications medium or tangible storage medium or logic processor.

### CROSS REFERENCE TO RELATED APPLICATIONS

This application claims priority from provisional patent application 61/427,467 filed Dec. 27, 2010 and 61/449,557 filed Mar. 4, 2011, each of which are incorporated herein by reference.

### GOVERNMENT RIGHTS CLAUSE

This application may include material supported by National Institutes of Health, Integrative Cancer Biology Program (ICBP), Grant U56 CA112973. The government may have certain rights in this invention.

### COPYRIGHT NOTICE

Pursuant to 37 C.F.R. 1.71(e), applicant notes that a portion of this disclosure contains material that is subject to and for which is claimed copyright protection (such as, but not limited to, source code listings, screen shots, user interfaces, or user instructions, or any other aspects of this submission for which copyright protection is or may be available in any jurisdiction.). The copyright owner has no objection to the facsimile reproduction by anyone of the patent document or patent disclosure, as it appears in the Patent and Trademark Office patent file or records. All other rights are reserved, and all other reproduction, distribution, creation of derivative works based on the contents, public display, and public performance of the application or any part thereof are prohibited by applicable copyright law.

### APPENDIX

This application is being filed with an electronic appendix. These appendices and all other papers filed herewith, including papers filed in any attached Information Disclosure Statement (IDS), are incorporated herein by reference. The appendix contains further examples and information related to various embodiments of the invention at various stages of development and sets out selected source code extracts from a copyrighted software program, owned by the assignee of this patent document, which manifests the invention.

### FIELD OF THE INVENTION

The present invention relates to sample collection and analysis and digital and computer systems and methods thereof.

### BACKGROUND OF THE INVENTION

The discussion of any work, publications, sales, or activity anywhere in this submission, including in any documents submitted with this application, shall not be taken as an admission that any such work constitutes prior art. The discussion of any activity, work, or publication herein is not an admission that such activity, work, or publication existed or was known in any particular jurisdiction.

Microarray systems are standard pieces of equipment in various biological investigation settings. A typical microarray includes thousands of locations, each able to probe generally a specific DNA sequence. Locations can have probes that are short section of a gene or other DNA element that are used to hybridize a cDNA or cRNA target from a biologic sample. Probe-target hybridization is usually detected and quantified to determine relative abundance of nucleic acid sequences in the sample. Since a microarray can contain tens of thousands of probes, a microarray experiment can accomplish many genetic tests in parallel. Microarray analysis has accelerated many types of investigation.

Microarray analysis systems can include a number of components for preparing samples, placing samples onto microarrays, reading the data from the microarrays, and providing one or more outputs or taking further actions in response to the data. While methods and components of such systems vary, operation of automated or semi-automated microarray data collection and analysis systems is extremely well-know in various biologic, medical, and forensic fields. While microarrays are most commonly used today to sample DNA or RNA sequences (commonly referred to as genes), microarray technology is increasingly being use or considered for other applications, such as protein analysis, chemical analysis, etc.

A critical component of microarray systems are computational tools that are applied to the feature expression levels collected by microarray systems. Because a single microarray experiment can include detection of thousands of feature expression level measurements from many samples, automated compilation and analysis of microarray data is an important component of microarray data systems. This analysis of microarray expression levels may be performed by information enabled laboratory equipment used to detect the feature levels from microarray samples, or the laboratory equipment can collect and store the feature levels in a digital recording medium and those data can be read and processed at a later time by microarray data processing equipment. A number of feature expression data sets from microarray experiments are published and are used to evaluate and validate new methods for analysis of microarray feature data.

Biological processes of development, differentiation and aging are increasingly being described by the temporal ordering of highly orchestrated transcriptional programs [1]. When such processes are analyzed with gene expression microarray analysis at specified time points, a variety of computational methods are available to identify which genes vary and how they vary across part or all of the time points [2-6].

However, when microarray samples of a biological process are available but their temporal or other developmental ordering is not known, fewer methods are available to recover the correct ordering, especially when the underlying process contains branchpoints, as occurs in the differentiation from hematopoietic stem cells to myeloid and lymphoid lineages.

Recovery of an ordering among unordered samples or objects with a large number of detectable features that are expected to vary in some gradual and meaningful way according to the sample ordering has been studied in a variety of contexts. In computer vision, images taken from random viewpoints and angles can be ordered for the purpose of multiview matching [7], where the ordering was based on predefined features that are invariant to different viewpoints. In genetics, spanning trees were applied to reconstruct genetic linkage maps [8], which was an ordering of genetic markers. Using gene expression data of a small set of preselected genes, phylogenetic trees were constructed to study cancer progression among microarray cancer samples [9, 10]. Microarray samples were also ordered by a traveling salesman path from combinatorial optimization theory, but feature selection was not discussed [11, 12]. Although these methods proved useful in the recovery of an ordering from unordered objects, their direct applications cannot address the challenges of extracting progression and differentiation hierarchy from microarray gene expression data. Algorithms in [7, 11, 12] assume linear ordering of unordered objects, and therefore are not able to reveal potential branchpoints. Furthermore, most existing methods order samples based on carefully designed or preselected features (e.g., such as genes or gene markers). However, in microarray gene expression data, meaningful gene features are usually not known a priori.

Thus, in various fields, methods for exploring or analyzing data sets where a number of samples (e.g., typically about 5 to about 100 samples, though any number of samples can be analyzed) are each characterized by generally a relatively large number of features (e.g., about 100 to about 1,000,000, more typically about 500 to about 10,000) remain limited.

### REFERENCES

1. Mandel E, Grosschedl R (2010) Transcription control of early b cell differentiation. Current Opinion in Immunology 22: 161-167.
2. Filkov V, Skiena S, Zhi J (2002) Analysis techniques for microarray time-series data. Journal of Computational Biology 9: 317-330.
3. Storey J, Xiao W, Leek J, Tompkins R, Davis R (2005) Significance analysis of time course microarray experiments. Proceedings of the National Academy of Sciences of the United States of America 102: 12837-12842.
4. Sacchi L, Larizza C, Magni P, Bellazzi R (2007) Precedence temporal networks to represent temporal relationships in gene expression data. Journal of Biomedical Informatics 40: 761-774.
5. Zhu D, Hero A, Cheng H, Khanna R, Swaroop A (2005) Network constrained clustering for gene microarray data. Bioinformatics 21: 4014-4020.
6. Huang Y, Wang J, Zhang J, Sanchez M, Wang Y (2007) Bayesian inference of genetic regulatory networks from time series microarray data using dynamic bayesian networks. Journal of Multimedia: 46-56.
7. Schaffalitzky F, Zisserman A (2002) Multi-view matching for unordered image sets, or “how do i organize my holiday snaps?”. In: ECCV '02: Proceedings of the 7th European Conference on Computer Vision-Part I. Springer-Verlag, pp. 414-431.
8. Wu Y, Bhat P, Close T, LonardiLott S (2008) Efficient and accurate construction of genetic linkage maps from the minimum spanning tree of a graph. PLoS Genet 4: e1000212.
9. Desper R, Khan J, Schaffer A A (2004) Tumor classification using phylogenetic methods on expression data. J Theor Biol 228: 477-496.
10. Park Y, Shackney S, Schwartz R (2009) Network-based inference of cancer progression from microarray data. IEEE/ACM Trans on Computational Biology and Bioinformatics 6: 200-212.
11. Magwene P, Lizardi P, Kim J (2002) Reconstructing the temporal ordering of biological samples using microarray data. Bioinformatics 19: 842-850.
12. Gupta A, Bar-Joseph Z (2008) Extracting dynamics from static cancer expression data. IEEE/ACM Trans Comput Biol Bioinformatics 5: 172-182.
13. Xu Y, Olman V, Xu D (2002) Clustering gene expression data using a graph-theoretic approach: an application of minimum spanning trees. Bioinformatics 18: 536-545.
14. Zhang B, Horvath S (2005) A general framework for weighted gene co-expression network analysis. Stat Appl Genet Mol Biol 4.
15. Margolin A A, Nemenman I, Basso K, Wiggins C, Stolovitzky G, et al. (2006) Aracne: an algorithm for the reconstruction of gene regulatory networks in a mammalian cellular context. BMC Bioinformatics 7.
16. Qiu P, Gentles A J, Plevritis S K (2009) Fast calculation of pairwise mutual information for gene regulatory network reconstruction. Computer methods and programs in biomedicine 94: 177-180.
17. Whitfield M L, Sherlock G, Saldanha A J, Murray J I, Ball C A, et al. (2002) Identification of genes periodically expressed in the human cell cycle and their expression in tumors. Molecular biology of the cell 13: 1977-2000.
18. Yip A M, Horvath S (2007) Gene network interconnectedness and the generalized topological overlap measure. BMC Bioinformatics 8: 22+.
19. Subramanian A, Tamayo P, Mootha V K, Mukherjee S, Ebert B L, et al. (2005) Gene set enrichment analysis: A knowledge-based approach for interpreting genome-wide expression profiles. PNAS 102:15545-15550.
20. Eisen M B, Spellman P T, Brown P O, Botstein D (1998) Cluster analysis and display of genome-wide expression patterns. Proc Natl Acad Sci USA 95: 14863-14868.
21. Hystad M E, Myklebust J, Bo T, Sivertsen E, Rian E, et al. (2007) Characterization of early stages of human b cell development by gene expression profiling. J Immunol 179: 3662-3671.
22. Aiba K, Nedorezov T, Piao Y, Nishiyama A, Matoba R, et al. (2008) Defining developmental potency and cell lineage trajectories by expression profiling of differentiating mouse embryonic stem cells. DNA Res 16: 73-80.
23. Chandran U, Ma C, Dhir R, Bisceglia M, Lyons-Weiler M, et al. (2007) Gene expression profiles of prostate cancer reveal involvement of multiple molecular pathways in the metastatic process. Current Opinion in Immunology 7: 64.
24. Tavazoie S, Hughes J D, Campbell M J, Cho R J, Church G M (1999) Systematic determination of genetic network architecture. Nat Genet 22: 281-285.
25. Furey T S, Christianini N, Duffy N, Bednarski D W, Schummer M, et al. (2000) Support vector machine classification and validation of cancer tissue samples using microarray expression data. Bioinformatics 16: 906-914.
26. O'Neill M C, Song L (2003) Neural network analysis of lymphoma microarray data: prognosis and diagnosis near-perfect. BMC Bioinformatics 4.
27. Qiu P, Plevritis S (2009) Simultaneous class discovery and classification of microarray data using spectral analysis. Journal of Computational Biology 16: 935-944.
28. Tusher V G, Tibshirani R, Chu G (2001) Significance analysis of microarrays applied to the ionizing radiation response. Proc Natl Acad Sci USA 98: 5116-5121.
29. Monti S, Tamayo P, Mesirov J, Golub'T (2003) Consensus clustering: A resampling-based method for class discovery and visualization of gene expression microarray data. Mach Learn 52: 91-118.
30. Pettie S, Ramach V (1999) An optimal minimum spanning tree algorithm. Journal of the ACM 49: 49-60.
31. Cox T, Cox M (2000) Multidimensional Scaling, Second Edition. Chapman & Hall/CRC.

### SUMMARY

The present invention, in specific embodiments, involves microarray analysis methods and systems for analyzing and displaying or otherwise presenting a progression or relationship model for a number of microarray samples where each microarray sample is characterized by a number of detected gene expression feature levels. According to specific embodiments, at least some of the features are expected to vary coherently according to a progression or relationship underlying the microarray samples. The invention provides methods and systems for both finding the progression or relationship among the samples and for determining which of the many features are relevant to the progression. Systems and methods of the invention can operate using a logic processor associated with a microarray analysis system and can operate on both newly collected gene expression levels and on stored gene expression levels.

The present invention, in specific embodiments, more generally involves methods and systems for analyzing and displaying or otherwise presenting or outputting a progression or relationship model for a number of samples where each sample is characterized by a number of features, at least some of which are expected to vary according to the progression or relationship of the samples. A sample can more generally represent one or more of various objects or concepts or groups under study (such as cells, tissues, organisms, traded stocks or securities, people, etc.) For purposes of this discussion, a feature can represent one to a relative large number of measurements or values that characterize a sample.

Example implementations, including implementations used for demonstration and experimentation, are referred to at times herein as a Sample Progression Discovery™ (SPD™) system and/or method. One particular field of interest is to discover patterns of biological progression underlying microarray data samples of gene expression features, protein expression features, or other biological markers. An illustrative biological implementation according to specific embodiments of the invention assumes that individual samples are related by an unknown biological process (e.g., differentiation, development, cell cycle, disease progression, cell transformation (fertilization, meiosis, mitosis, apoptosis, etc.) and that each sample represents one unknown point along the progression of that process. The invention, in general, aims to organize the samples in a manner that reveals the underlying progression or relationship and simultaneously identify the features or sets of features (e.g., gene or protein expressions or clusters or modules of gene or protein expression levels) that are responsible for that progression.

In specific embodiments, the invention may be viewed as a novel tool for identifying relationships or orderings of samples and which features are important for determining those relationships. The invention provides a likely progression underlying a set of samples of microarray data and identifies candidate features (e.g., genes or other factors) that regulate or are associated with that progression. In more general terms, SPD can identify relationships and relevant features for sample sets with a large number of features that both determines how samples are related to each other (e.g., a linear or branched progression) and which features are most likely important in that interrelation of samples. In contrast to the majority of microarray data analysis methods, which focus on identifying differences between sample groups (e.g., normal vs. cancer, treated vs. control), the invention identifies an underlying progression among individual samples.

For example, when applied to a microarray dataset of cancer samples, in particular applications, the invention provides an analysis and output assuming that the cancer samples collected from individual patients represent different stages during an intrinsic progression underlying the cancer development. The relationship of the samples determined by the invention among indicates a pathway or hierarchy of the cancer progression. In some applications, the progression determined by the invention can serve as a further hypothesis to be tested and may reveal new information about how samples are related and also about which features are important in driving the progression of a sample from one state to another state. The invention can effectively discover the progression among samples, even if the progression contains branchpoints, while simultaneously identifying features that define the progression. Assuming the underlying progression can be reflected by gradual expression changes of subsets of features (e.g., genes), SPD selects features whose gradual changes support a common progression and presents the common progression as potentially biologically meaningful.

As discussed above, methods and systems of the invention have applications other than microarray data analysis or analysis of other biologic systems such as flow-cytometry, blot analysis, proteomics analysis, etc. The invention can be applied to a variety of high-dimensional feature measurements, including genomic, proteomic, population, economic, chemical, astrophysics, particle physics, and image-based data.

In addition, the invention has applications to other progression analysis of large datasets. Such datasets can include the progression of consumer decisions to make certain purchases, the progression of citizens in utilization of government resources or services, progression of individuals under criminal justice supervision to either rehabilitation or recidivism, or other instances where it is desired to analyze very large data sets of samples to determine progression from one state to another of objects those samples represent.

As one example, the invention can be used to analyze certain economic actors. Consider analysis of individual stocks in a stock marker. Each stock represents a company that can be modeled as being at some point in a progression or differentiation from start up, to going public, to becoming profitable and a blue chip stock, to becoming part of a stock bubble, or to going bankrupt. Thousands of features may be measured about each stock at a given point of time. In this analysis, the invention would attempt to find a progression or differentiation of stocks from an initial state, such as a start up, through other states, such as going public, or going private, or going bankrupt. The invention would attempt to both identify progressions and differentiations and feature modules that are important in determining progressions of stocks. Of course, there may be sample sets with feature sets that are analyzed by the invention that in fact have no progression relationship that is supported by the measured features. In such a case, the invention can provide a negative output, indicating that no likely progression relationships could be found.

The more common machine learning methods that have been used to analyze microarray data include unsupervised clustering [19, 24], supervised classification [25, 26, 27], and statistical tests for differential expression [20, 28]. Although these algorithms are quite different from each other, they share a similar goal, which is to identify differences between different sample groups, e.g., normal vs. cancer. When applied to study a progressive biological process, these methods essentially bin the process into stages and identify differences between sample groups, without providing a hypothesis or analysis of the underlying stages or progression of the samples. The invention, instead of assuming that samples in the same group are similar and focusing on the differences between groups, treats individual samples as different points during an unknown biological progression or other relation, and thus has the potential to discover how samples progress both within and across groups.

The invention, as far as the inventors are aware, is unique in its ability to simultaneously identify both the progression relationship among samples and the features (e.g., genes) that are associated with the progression, without prior knowledge or manual feature selection. According to specific embodiments of the invention, SPD evaluates similarity between feature modules based on whether they are concordant with common progression patterns represented by MSTs. In contrast to correlation and regression-based methods [14-16] where the expression profiles of modules are directly compared with each other, SPD evaluates progression similarities between modules via MSTs.

The invention according to specific embodiments further involves a new similarity measure: progression similarity. This measure evaluates similarity between features or feature modules based on whether they are concordant with common progression patterns represented by MSTs. In contrast to correlation and regression-based methods [14,15,16] where the expression profiles of gene modules are directly compared with each other, SPD evaluates progression similarities between feature modules via MSTs. Experiments using the invention have demonstrated that modules that are similar in terms of progression similarity do not necessarily correlate with each other. This result demonstrates that the invention is able to identify similarities that correlation and regression-based analyses may miss.

According to specific embodiments, invention can be understood as a method for identifying a progression among samples while simultaneously determining relevant features comprising four steps: (1) clustering features into a smaller number of feature modules, where modules are determined by comparing features across multiple samples; (2) determining per-module progressions (e.g., a per-module MST) for each of some or all of the modules; (3) identifying progression-similar modules, by identifying which modules have high progression similarity to multiple per-module progressions; (4) using the progression-similar modules to determine a most likely overall progression.

While aspects and implementations of the invention will vary according to particular applications (e.g., population or economic analysis versus biologic progression analysis), the invention is best described and understood by considering a number of specific example applications. These example applications are taken from the field of biologic microarray data analysis and some experimental results are discussed.

Microarray (MA) datasets are well understood and are generally a very tall and very thin data matrix, indicating that there are many genes for which data is captured (the features), but over a relatively small number of samples. Generally, a sample is something like one patient or one individual or one tissue or one cell (or cell population) and the features for a sample are generally the data from one entire microarray. One typical example microarray data set might have from about 15 to about 500 samples, with each sample potentially containing measurements of about 1000 to about 20000 genes or features. In one example discussed at length below, 17 samples are analyzed with 3196 gene expression data values from each sample.

The effectiveness of example implementations has been demonstrated on a variety of microarray datasets that included samples from a biological process at different points along its progression. The invention analysis was performed without any a priori information of the underlying process. For example, when applied to a cell cycle time series microarray dataset, SPD was not provided prior knowledge of samples' time order or of which genes are cell-cycle regulated; yet SPD recovered the correct time order and identified many genes that have been associated with the cell cycle. SPD applied to B-cell differentiation data also recovered the correct order of stages of normal B-cell differentiation and the linkage between preB-ALL tumor cells with their cell origin preB. When applied to mouse embryonic stem cell differentiation data, SPD uncovered a landscape of ESC differentiation into various lineages and genes that represent both generic and lineage specific processes.

Various methods for analyzing data can be employed in specific embodiments. According to specific embodiments, of the invention is directed to cluster creation and determines one or more useful clusters, groupings, and/or populations to which the data belongs. The invention can be used in several areas including flow cytometry analysis and analysis of marketing data. The invention may also be used with in any field in which it is found helpful to cluster and/or group data.

The invention and various specific aspects and embodiments will be better understood with reference to the following drawings and detailed descriptions. In some of the drawings and detailed descriptions below, the present invention is described in terms of the important independent embodiment of a system operating on a digital device or data network. This should not be taken to limit the invention, which, using the teachings provided herein, can be applied to other situations, such as cable television networks, wireless networks, etc. For purposes of clarity, this discussion refers to devices, methods, and concepts in terms of specific examples. However, the invention and aspects thereof may have applications to a variety of types of devices and systems. It is therefore intended that the invention not be limited except as provided in the attached claims.

It is well known in the art that logic systems and methods such as described herein can include a variety of different components and different functions in a modular fashion. Different embodiments of the invention can include different mixtures of elements and functions and may group various functions as parts of various elements. For purposes of clarity, the invention is described in terms of systems and/or methods that include many different innovative components and innovative combinations of innovative components and known components. No inference should be taken to limit the invention to combinations containing all of the innovative components listed in any illustrative embodiment in this specification. The functional aspects of the invention that are implemented on a computer, as will be understood from the teachings herein, may be implemented or accomplished using any appropriate implementation environment or programming language, such as C, C++, Cobol, Pascal, Java, Java-script, HTML, XML, dHTML, assembly or machine code programming, etc. In the interest of clarity, not all features of an actual implementation are described in this specification. It will be understood that in the development of any such actual implementation (as in any software development project), numerous implementation-specific decisions must be made to achieve the developers' specific goals and subgoals, such as compliance with system-related and/or business-related constraints, which will vary from one implementation to another. Moreover, it will be appreciated that such a development effort might be complex and time-consuming, but would nevertheless be a routine undertaking of software engineering for those of ordinary skill having the benefit of this disclosure.

All references, publications, patents, and patent applications cited herein are hereby incorporated by reference in their entirety for all purposes. All documents, data, or other written or otherwise available material described or referred to herein, is herein incorporated by reference. All materials in any IDS submitted with this application are hereby incorporated by reference.

When used herein, “the invention” should be understood to indicate one or more specific embodiments of the invention. Many variations according to the invention will be understood from the teachings herein to those of skill in the art.

### OTHER FEATURES & BENEFITS

The invention and various specific aspects and embodiments will be better understood with reference to the following drawings and detailed descriptions. For purposes of clarity, this discussion refers to devices, methods, and concepts in terms of specific examples. However, the invention and aspects thereof may have applications to a variety of types of devices and systems. It is therefore intended that the invention not be limited except as provided in the attached claims and equivalents.

### BRIEF DESCRIPTION OF THE FIGURES

The file of this patent contains a least one drawing executed in color. Copies of this patent with color drawings will be provided by the United States Patent and Trademark Office upon request and payment of the necessary fee.

FIG. 1 illustrates a flowchart of a method for ordering samples of microarray expression levels in a microarray system according to specific embodiments of the invention.

FIG. 2A-F illustrate an example of a graphical output of results of a progression analysis in an analysis system according to specific embodiments of the invention.

FIG. 3A-B illustrate an example of a graphical output of results of a progression analysis in a analysis system according to specific embodiments of the invention of microarray system expression levels from samples of normal B-cell differentiation, with (a) all samples; (b) cancer samples and outliers next to cancer samples removed.

FIG. 4A-B illustrate an example of a graphical output of results of a progression analysis in a analysis system according to specific embodiments of the invention of microarray system expression levels from samples of mouse embryonic stem cell differentiation according to specific embodiments of the invention.

FIG. 5A-D illustrate an example of a graphical output of results of a progression analysis in a analysis system according to specific embodiments of the invention of microarray system expression levels from samples derived from prostate cancer patients according to specific embodiments of the invention.

FIG. 6 is a block diagram showing a representative example logic device in which various aspects of the present invention may be embodied.

FIG. 7 is a block diagram illustrating various embodiments of the present invention incorporated into a microarray processing and analysis system further including wet or physical processing and/or delivery of a physical result and/or output of results data.

### DESCRIPTION OF SPECIFIC EMBODIMENTS

Before describing the present invention in detail, it is to be understood that this invention is not limited to particular compositions or systems, which can, of course, vary. It is also to be understood that the terminology used herein is for the purpose of describing particular embodiments only, and is not intended to be limiting. As used in this specification and the appended claims, the singular forms “a”, “an” and “the” include plural referents unless the content and context clearly dictates otherwise. Thus, for example, reference to “a device” includes a combination of two or more such devices, and the like.

Unless defined otherwise, technical and scientific terms used herein have meanings as commonly understood by one of ordinary skill in the art to which the invention pertains. Although any methods and materials similar or equivalent to those described herein can be used in practice or for testing of the present invention, the preferred materials and methods are described herein.

The present invention automatically discovers biological progression, including branching, from underlying multidimensional high throughput data samples and automatically identifies relevant features without the need for a user's prior expert knowledge. One form of biological progression is cellular differentiation, and it is the focus of several examples provided in this application. As discussed above, the invention has applicability to progression in general and may relate to natural cellular or organism biological progression, clinical disease progression of cells or organisms, treatment response of cells or organisms, progression of cells or organisms under various investigation studies or stimulations. In addition, the invention has applications to other progression analysis of large datasets.

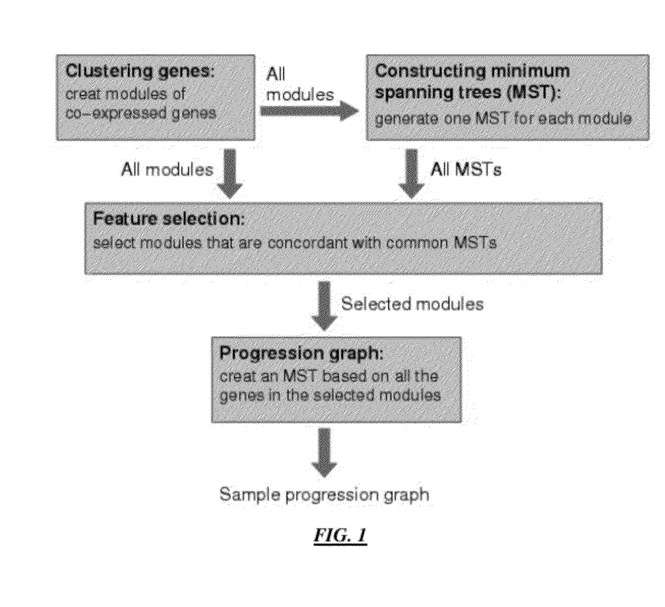

According to further specific embodiments of the invention, the invention as depicted in FIG. 1 discovers sample progression from features determined by gene expression microarray data using four steps: (1) clustering features (e.g., genes) into a smaller number of feature modules (e.g., gene modules), where modules are determined by comparing features (e.g., gene expression) across multiple samples; (2) determining per-module progressions (e.g., a per-module MST) for each selected module; (3) identifying progression-similar feature modules, by identifying which feature modules have high progression similarity to multiple per-module progressions; and (4) using the progression-concordant feature modules to determine a most likely overall progression.

These steps are explained below in general terms. To further elucidate the invention according to specific embodiments, the method steps are also described below with reference to a particular illustrative example, which is denoted herein as Example 1. After the general description, application of the invention to other example datasets are provided.

### Feature Clustering to Determine Feature Modules

According to specific embodiments of the invention, clustering of features into modules is used to reduce the number of features (e.g., gene expression levels) to be tested. In particular embodiments, the invention employs a iterative consensus k-means algorithm believed to be novel in this application to perform clustering and thereby derive coherent modules. In one example, genes within each module are selected to be highly co-expressed. Feature clustering reduces data dimension and noise. It is well known that gene clustering is a difficult optimization problem with many local minimums, such that most clustering algorithms lack consistency and reproducibility across multiple runs [29] The present invention employs an iterative consensus k-means algorithm to derive consistent coherent modules. The algorithm is an iterative divisive hierarchical clustering procedure. In every iteration, each module from the previous iteration that has not reached one or more stopping criteria is divided into two modules, until an overall stopping criteria is met. An example implementation of the algorithm are discussed below. A further example implementation is provided in the source code appendix, incorporated herein by reference.

According to specific embodiments, given an N by M gene expression data matrix (e.g., where N=3196, indicating the number of genes or features and M=17, indicating the number of samples), the k-means algorithm is performed L times, with random initialization, to cluster the N features into k=2 clusters. Clustering results are arranged into an N by L matrix, where the (i; j) element is the cluster assignment of feature (gene) i in the jth run of k-means. In a typical embodiment, during each iteration of k-means, each feature is assigned to one of two clusters, so the values in the N by L matrix are binary (e.g., “0” or “1”).

In order to draw the consensus of the L runs of k-means, the invention applies k-means again based on the N by L matrix to divide the features into two clusters. For each of the two clusters, the cluster coherence is computed as the average Pearson correlation between each gene in the cluster and the cluster center. If the coherence of a cluster is higher then a pre-specified threshold (e.g., c₁), this cluster is a coherent module. Otherwise, this cluster is further partitioned by iterating the algorithm, with a matrix where N is equal to the number of features in the new gene set undergoing clustering.

After the iterative process ends, the invention examines the resulting coherent modules pairwisely. If the Pearson correlation of two modules' centers is higher than a pre-specified threshold c₂, these two modules are merged. This step iterates until no module pair share correlation higher than c₂.

In contrast to the agglomerative hierarchical clustering method, the iterative consensus k-means algorithm is a divisive top-down approach. The stopping criterion of cluster coherence guarantees that all resulting modules satisfy the pre-specified coherence threshold c₁. Modules that share correlation higher than c₂ are merged, so that the resulting gene modules are not highly correlated with each other. (One example experimental embodiment used algorithm parameters of about L=200, c₁=0.7, c₂=0.9.)

In Example 1, the sample data set comprised expression data for 3196 high variance features (genes) across 17 unordered samples from one cell cycle. This data set represents data collected from 17 microarray plates, each providing expression levels of 3196 genes. For experimental purposes, five cell cycle datasets published in [17] were independently analyzed by the invention. In each case, the invention was given no information about the temporal ordering of the samples. The temporal ordering determined and output by the invention was then compared with the know ground-truth ordering provided in [17] in order to validate the methods of the invention. Using otherwise characterized data, the invention was able to determine the underlying biological progression and identify the genes associated with that progression. Below is discussed the SPD analysis on the series with the largest number of samples. SPD analysis of the other time series can be found in Supplement. The analysis was deliberately limited to samples in one cell cycle to avoid the possibility that the invention would order the samples using the cyclic behavior of cell-cycle regulated genes. In this example, SPD clustered the 3196 high variance genes into 154 modules of co-expressed genes, using the iterative consensus k-means approach discussed above.

### Constructing Per-Module Minimum Spanning Trees

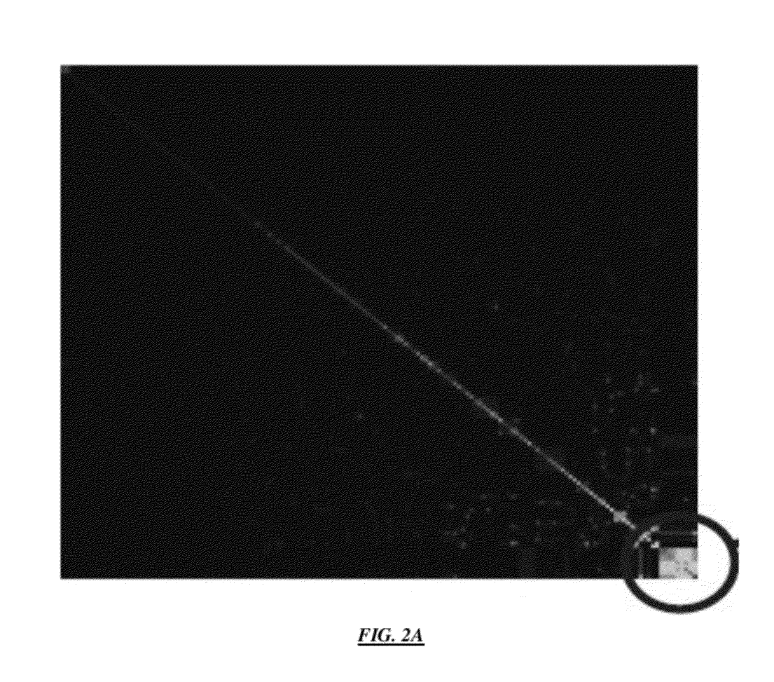

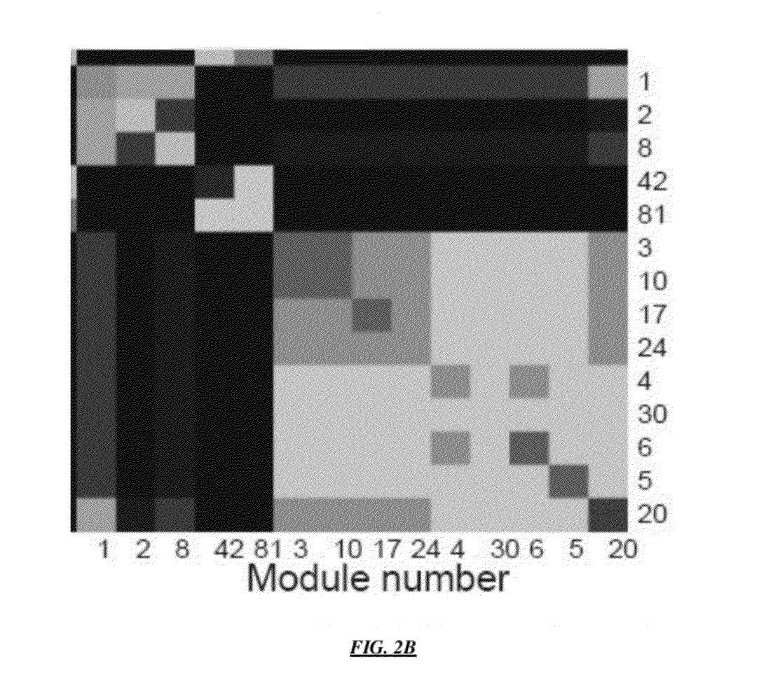

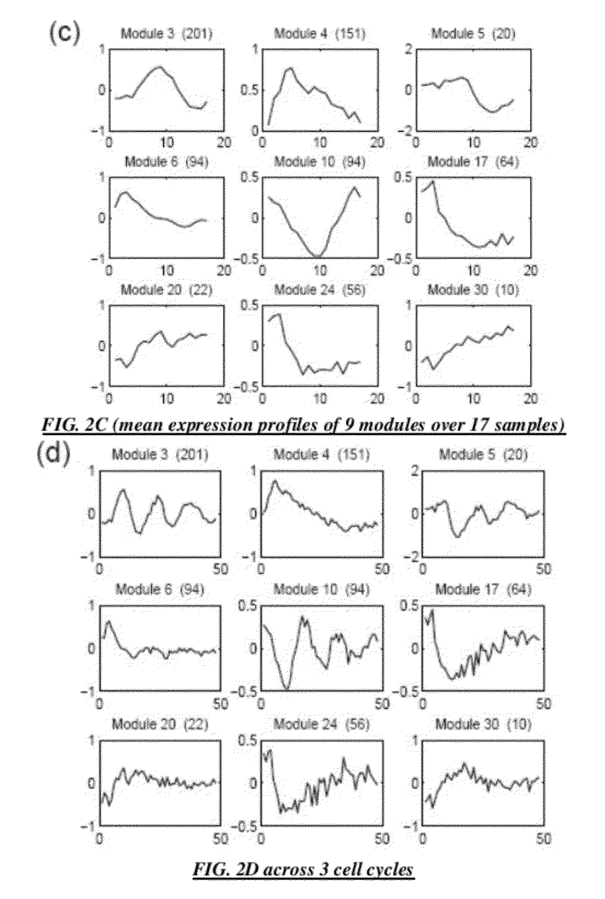

For each module, a minimum spanning tree (MST) is constructed, for example, as discussed in [13]. The nodes of the MST are the microarray samples (e.g., 17 samples from 17 different microarrays) and the edges are weighted by the distance between samples' gene expression profiles. Given a connected undirected weighted graph, the minimum spanning tree (MST) is a subgraph that connects all the nodes (e.g., 17 samples) with minimum number of edges and minimum total edge weights. An MST is acyclic. The number of edges equals the number of nodes minus one. (A graphical representation of an overall MST in shown in FIG. 2(e). The per-module MSTs have a similar form, but do not give the same progression in this example, as discussed below.) The invention uses the MST to describe the progression among the samples. As illustrated in various examples below, the progression derived according to specific embodiments of the invention is not necessarily linear, and can contain branching points.

In order to construct an MST for a set or cluster or module of genes, a fully connected undirected weighted graph is defined. In this example, each node represents one sample. The weight on the edge that connects nodes i and j is defined as the Euclidean distance between the feature (gene) expressions of samples i and j. The invention then derives the MST from the fully connected graph using Boruvka's algorithm [30]. Since the MST connects all the nodes using minimum total edge weights, it tends to connect samples that are more similar to each other. Starting from one sample and moving along the edges of the MST, a gradual change of feature (gene) expression is observed. Therefore, the MST reflects the progression among samples, defined by the gradual change of the gene cluster based on which the MST is constructed. In Example 1, one per-module MST was constructed for each of the 154 modules. Each per module MST represented a possible progression order of the samples based on the features of its corresponding module.

### Determining Progression Similarity Between Modules and Trees

An important aspect of the invention is the comparison between modules and trees constructed from other modules. To do this, the invention performs the following analysis. For example, given the expression data of a gene module x in M samples, define an M by M distance matrix D for each module, where Dᵢⱼ is the Euclidean distance between the features (e.g., gene expression profiles) of samples i and j. Further define an M by M adjacency matrix A of each per-module tree, where Aᵢⱼ=1 if samples i and j are directly connected in that tree and otherwise Aᵢⱼ=0. (In alternative embodiments, could be assigned different values based on the degrees of separation between samples i and j, so that, for example, Aᵢⱼ=½ if samples i and j are connected through one node, and ¼ if connected through 2 nodes, etc. In some embodiments, negative values could indicate distances of greater than a certain number of nodes.)

The concordance between a feature module and a tree is equivalent to the concordance between the distance matrix D of the feature module and the adjacency matrix A of the tree. Normally, the statistical concordance between D and A includes two aspects: (1) the distance between connected samples should be small, and (2) the distance between not-connected samples should be relatively larger [31]. In the present example analysis, the only focus is on the former aspect. The rationale is that, it is desirable to model progressions where the gene expression first drifts away from an initial state and then comes back. One such example is the cell cycle. The invention defines the statistical concordance (s) between distance matrix D and adjacency matrix A as shown in Eq. 1. The meaning of s is the total edge weights jointly defined by the module and the tree.

$$s = {\sum }_{{A}_{ij} = 1} {D}_{ij} \qquad ( 1 )$$

In order to derive the p-value of s, according to specific embodiments, the invention performs random permutations by randomly permuting the columns of the expression data. This is equivalent to reshuffling the rows and columns of the distance matrix D. The p-value is the probability of obtaining a smaller s during random permutations. In one example embodiment, about 2000 permutations are performed and a p-value threshold of 0.001 is used to determine whether a module and a tree are sufficiently concordant. The permutation value of 2000 is selected in accordance with the particular example described herein. In datasets with more samples, it may be desirable to do more or many more permutations. Likewise with datasets with a very large number of features. Adjustments of the particular thresholds or other parameters described herein to provide desired analysis of datasets with different characteristics will be understood in the art.

Selecting Modules that Support Common Progressions

Using Equation (1), the invention evaluates the statistical concordance between all the modules and all the MSTs. Since each MST is constructed based on one module, an MST and its corresponding module are concordant by construction. If a module is concordant with the MST derived from another module, these two modules are similar in the sense that they support a common progression pattern. According to specific embodiments, the progression similarity between two or more feature modules indicates the number of progressions supported in common by the modules. In one straightforward implementation, this value is simply an integer count of progression concordant with the module according to a selected threshold as described above. In other example implementations, the progression similarity may include weighting factors or non-integer values to indicate more varying degrees of similarity.

Based on the statistical concordance between all the modules and all the MSTs, a progression similarity matrix is derived. The progression similarity matrix quantifies the progression similarity between pairs of modules. In one implementation, the (u; v) element of the progression similarity matrix is the number of MSTs that are concordant with both modules u and v. For visualization, the progression similarity matrix is re-ordered by hierarchical clustering of the columns to more easily identify similar modules along the diagonal, via visual inspection [14]. If there is a diagonal block whose entries all have relatively high values, e.g., FIG. 2(a), the corresponding modules are similar because they describe a common progression.

Human visual inspection has proven beneficial according to particular embodiments of the invention and is a presently preferred method, but a variety of automated threshold detection or edge detection techniques can be used to determine a desired diagonal in the progression similarity matrix. Various edge and boundary detection techniques are well known in the art and their application to determine a diagonal block in the similarity matrix would be a straightforward application. (For example, see Konishi et al, Statistical Edge Detection: Learning and Evaluating Edge Cues, IEEE Transactions on Pattern Analysis and Machine Intelligence archive, Volume 25 Issue 1, January 2003, and the articles cited therein.)

An example progression similarity matrix using Example 1 is shown in FIG. 2(a). In this example, 154 modules were arranged so that those modules with the highest overall progression similarity as measured against each of the 154 modules were aligned furthest to the right and bottom of the figure. Doing so in this example revealed a clear block of 9 modules that had high progression similarity. An enlarged view of this portion is shown in FIG. 2(b) to highlight nine modules (3, 10, 17, 24, 4, 30, 6, 5 and 20) that are similar in terms of progression. The color-coding of the figures uses red to indicate a high progression similarity score and blue to indicate a low score, with yellow intermediate, as is commonly understood. For some data sets, the display or edge detection will determine that there is no clear diagonal block. In that case, the invention may output as a result that there is not coherent progression among the samples determined by the feature set.

To validate the analysis, the mean expression profiles of the nine modules over the 17 samples over one cell cycle ordered according to the known ground truth are shown in FIG. 2(c). It is of particular interest to note that some of these modules are uncorrelated with one another (e.g., modules 10 and 30 have a correlation of −0.06) according to various standard methods of determining correlation between data sets. However, according to specific embodiments, the invention is able to identify such feature modules as having a similarity in terms of progression.

To further illuminate the analysis, the mean expression profiles of the nine modules over the 17 samples ordered according to the known ground truth across three cell cycles (provided in the original dataset) are shown in FIG. 2(d). Here, it is shown that some of the identified modules are cyclic across the three cell cycles, indicating those feature modules varied meaningfully within each cell cycle. A likely explanation for the presence of the acyclic modules (e.g., modules 4, 6, 17, 20, 24, and 30) is that they represent the experimental perturbation that initially synchronized the cells. In the cell cycle microarray experiments, the population of cells were first synchronized, and then released with samples of the population taken at different times then exposed to microarrays for feature capture. This initializing synchronization condition is a cellular perturbation that can take several cell cycles to decay away.

As further validation of the invention, gene sets in the Molecular Signatures Database (MSigDB) [20] were used to annotate the gene modules that were identified according to the invention as significant in terms of progression. The modules identified as significant by the invention included many genes that have been previously associated with the cell cycle. For example, module 10 was highly enriched (p ˜10⁻⁷, hypergeometric test for gene set enrichment) for genes that are targets of the E2F cell cycle transcription factor family.

### Using High Progression Similarity Modules to Determine Overall Progression

According to specific embodiments of the invention, a further step in the analysis is to combine feature modules with the highest progression similarity to construct an overall MST. In specific applications, this overall MST is the invention's determination of the relationships between the samples and can be output to a user or other equipment and/or can be used to direct further manipulation and investigation of the samples. According to specific embodiments of the invention, the overall minimum spanning tree (MST) is constructed, for example, as discussed in [13] and as done for each of the per-module MSTs, but in this case, the feature set used in the MST analysis is the combined features from the selected modules.

In Example 1, the nine gene modules with the highest progression similarity were combined to construct an overall progression determination for the 17 cell cycle samples. The overall MST was visualized using high dimensional embedding, shown in FIG. 2(e). This MST revealed a near perfect restoration of the sample order. In this example, the per-module MSTs constructed from each of the nine modules did not recover the correct order because the progression was being analyzed over fewer features. Thus, the invention was able to determine a more accurate progression analysis by combining the selected feature modules than any one feature module was able to determine.

### Validation Experiments Using Example 1 Dataset

To further validate the invention and demonstrate the value of the overall MST versus the individual-module MSTs, a Topological Overlap Measure (TOM) [18] distance metric was used. The TOM compared the distance between the per-module MSTs, the overall progression MST, and a progression determined using prior art single linkage, to the known ground-truth sample order. This comparison is shown in Table 1.

TABLE 1

| | TOM network distance |
|---|---|
| SPD Overall | 4.33 |
| Module 3 MST | 17.33 |
| Module 4 MST | 19.33 |
| Module 5 MST | 24.00 |
| Module 6 MST | 18.33 |
| Module 10 MST | 20.17 |
| Module 17 MST | 35.67 |
| Module 20 MST | 45.57 |
| Module 24 MST | 29.33 |
| Module 30 MST | 26.00 |
| single linkage HC | 42.50 |
| (prior art) | |

Table 1 presents the topological overlap measure (TOM) distance between the extracted sample progression patterns and the known true sample order for cell cycle time series data. The first row (labeled SPD Overall) shows that the overall MST based on combining the nine modules produced a more accurate sample order (with a TOM distance of 4.33) than the MSTs derived from any of the individual modules, shown in the next nine rows. Table 1 also shows a comparison with SPD to the commonly used hierarchical clustering (HC) analysis of the dataset described above. An MST is somewhat similar to a hierarchical clustering tree with single linkage [19]. Unlike hierarchical clustering, SPD selects gene modules that share progression similarity, and reconstructs an overall MST that describes the common progression.

To further illustrate the significance of SPD's feature selection ability, the dataset in Example 1 was analyzed using a single linkage hierarchical clustering based on all the 3196 genes, which is equivalent to constructing an MST based on all these genes. The resulting dendrogram (shown in FIG. 2(f)) did not recover the correct sample order. Moreover, the TOM distance between the hierarchical clustering tree and the true sample order was much larger than that from SPD. This demonstrates the importance of feature module selection according to specific embodiments of the invention.

As further validation, to evaluate the robustness of SPD, we performed bootstrap analysis on the cell cycle microarray dataset. In each of the 100 bootstrap iterations, 90% of the 3196 genes were randomly selected. SPD was applied to each bootstrapped dataset separately. In each bootstrapped dataset, the clustering step might generate different gene modules that lead to different progression related modules and a different overall MST. However, the overall MSTs were consistent across the bootstrapped datasets. TOM distance was used to evaluate the distance between the 100 SPD results and the true sample order. The mean TOM distance was 536±337. The standard deviation of the TOM distance appeared to be comparable to the mean due to the statistical properties of TOM. To evaluate the statistical significance of this result, we performed random permutation analysis. We generated 1000 random MSTs, and computed the TOM distance between random MSTs and the true sample order. The mean of the random TOM distance was 59±8, which is substantially larger than the TOM distances obtained in the bootstrap analysis, indicating the robustness of SPD.

In addition, we examined the diameters of the random MSTs, where the diameter is defined as the number of edges in the shortest path between the most distantly separated pair of nodes. The mean diameter of a random 17-node MST was 73±1:4. The diameter of the SPD result in FIG. 2(c) was 15. The probability of obtaining such a large diameter by chance was low, which implied that the SPD result was statistically significant.

### Example 2

### Recovering Stages of B-Cell Differentiation

In a further experiment, the invention was applied to a B-cell differentiation dataset [21]. In this particular example dataset, 9365 gene feature measurements from 44 cell samples across 5 normal cell differentiation stages and 1 malignant stage were captured from microarrays. The 44 samples were distributed as follows:

| | |
|---|---|
| 7 | hematopoietic stem cells (HSC) |
| 7 | common lymphoid progenitors (CLP) |
| 7 | proB cells |
| 7 | preB cells |
| 7 | Immature B cells (IM) |
| 5 | more terminally differentiated B cells (1 Naive B cell, |
| | 1 centroblast CB, 1 centrocyte CC, 1 memory B cell, |
| | 1 CD19+ cell) |
| 4 | preB-ALL cancer samples. |

Using the methods described above, the invention was used to determine the progression of this data set. For validation purposes, the output clustering and progression of the invention was compared with the known progression, which is:
HSC→CLP→proB→preB→naiveB/CB/CC/memoryB/CD19+.

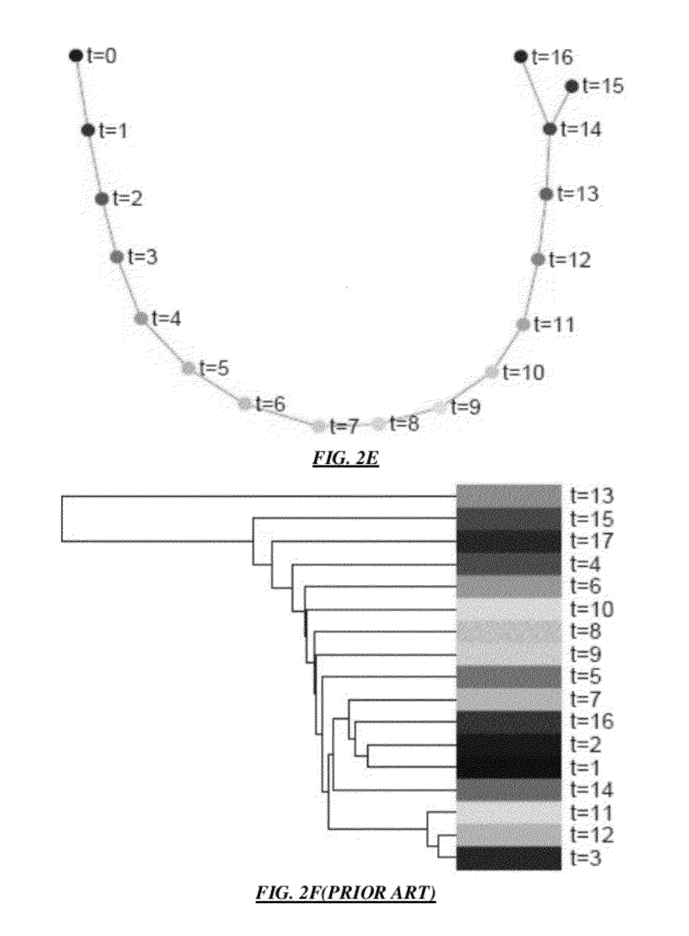

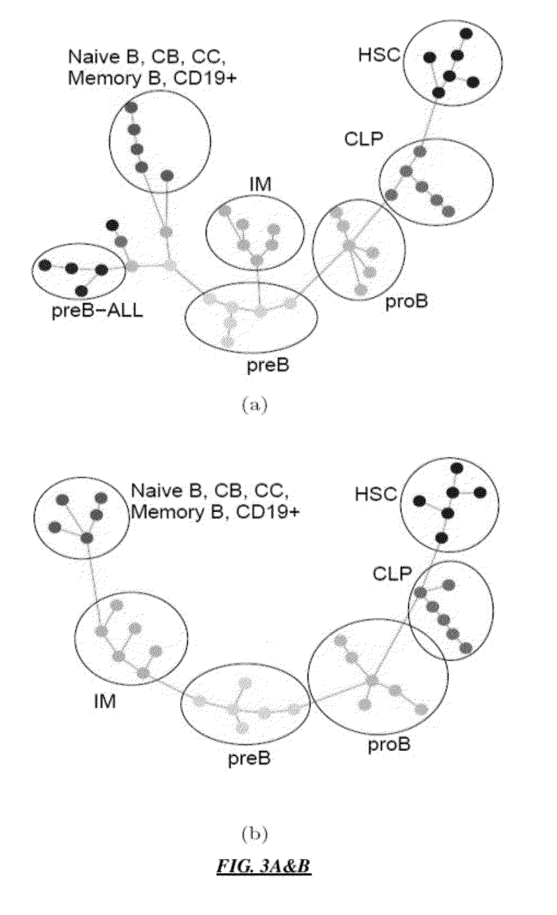

Another objective of this experiment was to determine whether the preB-ALL would be grouped near its preB cell origin. In one example implementation, the invention selected 10 gene modules (composed of 2388 genes in total) that supported a common progression. Based on these modules, an overall MST was constructed to describe the progression. FIG. 3(a) is an illustration of an overall MST determined according to specific embodiments of the invention. In this figure, the progression is illustrated progressing from right to left. The sample node locations (illustrated as dots) and edges are output as determined by the invention. Color coding is added in this figure based on the known differentiation stage of the cells to show the relative accuracy of the analysis according to the invention. Sample nodes are color-coded according to their known ground-truth classification: HSC (violet), CLP (blue), proB (light blue), preB (green), immature (yellow), naiveB/CB/CC/memoryB/CD19+ (red), preB-ALL (brown). Group outlines are added to highlight each class of samples for illustrative purposes. While this color-coding is based on known classifications, according to specific embodiments of the invention can provide a color coding based on any desired criteria, such as module or feature expression levels, or any known sample clustering technique used to characterize the samples.

As seen in the figure, the identified progression was consistent with the known stages of normal B-cell differentiation, except for a missing link between immature B cells and the next more differentiated B cells (naiveB/CB/CC/memoryB/CD19+). The link between preB-ALL cancer samples and their cell origin (normal preB cells) was identified. The link between immature B cells and more differentiated B cells was missing, partly because MSTs do not allow for cycles.

To further understand the performance of SPD, it was hypothesized that removal of the cancer samples and the outliers that are grouped next to the cancer samples, the missing link would be restored. The resulting MST was consistent with the six stages of normal B-cell differentiation described above. This is illustrated in FIG. 3(b). Some modules contained genes that relate to B-cell differentiation but are generic in their function. Examples include proliferation genes (p=3×10⁻¹², hypergeometric test), which are highly expressed in germinal center B-cells that are undergoing rapid expansion, but down-regulated at other stages.

In this experiment, the invention also recovered modules of genes that are specific to B-cell differentiation. These were enriched in genes that are known markers of, or mechanistically related to, B-cell differentiation such as CD19, CD20, CD79 (B-cell receptor), and the master transcription factors PAX5 and SP140. There was also observed enrichment (p=2×10′⁷) for genes in the B-cell receptor (BCR) pathway, which is the key signaling pathway governing the maturation of B-cells.

Furthermore, this experiment illustrates an output of the invention in which there are multiple instances of samples that have similar features. In this case, as above, each sample is represented as a separate node (or dot) on the graph. In the output, the invention closely connected samples from cells in the same differentiation stage, such that those samples are grouped together in the progression. As elsewhere, the number of differentiation stages and the identity of the samples were not provided as an input to the invention, the invention made the determination based on the feature analysis discussed above. Thus, in this example, the invention not only determines the progression, but also groups together samples that are similar in terms of their progression, thereby revealing potentially meaningful groups within a large sample set.

### Example 3

### Embryonic Stem Cell Differentiation

As is well understood in the art, pluripotent embryonic stem cells (ESCs) are capable of differentiating into all cellular lineages in the development of a mature organism. As a further experimental test, the invention was applied to a dataset of 88 microarrays (representing 44 samples in duplicate) of mouse ESCs and ESC progeny that had been induced to differentiate into several lineages by specific interventions, as well as several differentiated cell types. Interventions in this experiment included knockdown of Pou5f1/Oct4 (leading to differentiation to trophoblasts), induction of GATA6 (differentiation to endoderm lineage), treatment with N2B27 medium (differentiation to neural lineages), and all-trans retinoic acid (RA) induction of embryonic carcinoma cells to cause differentiation [22]. The data in the dataset included time series along each lineage of cells.

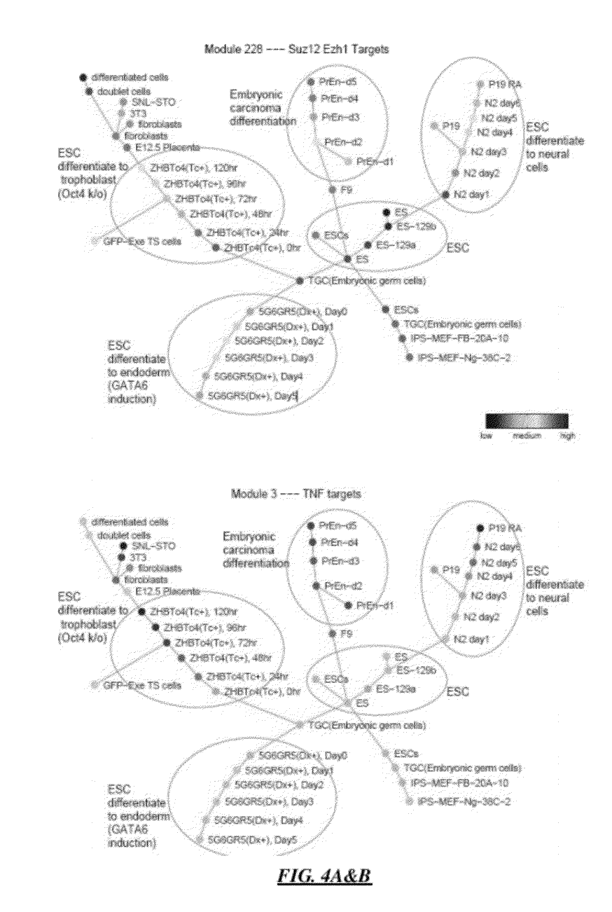

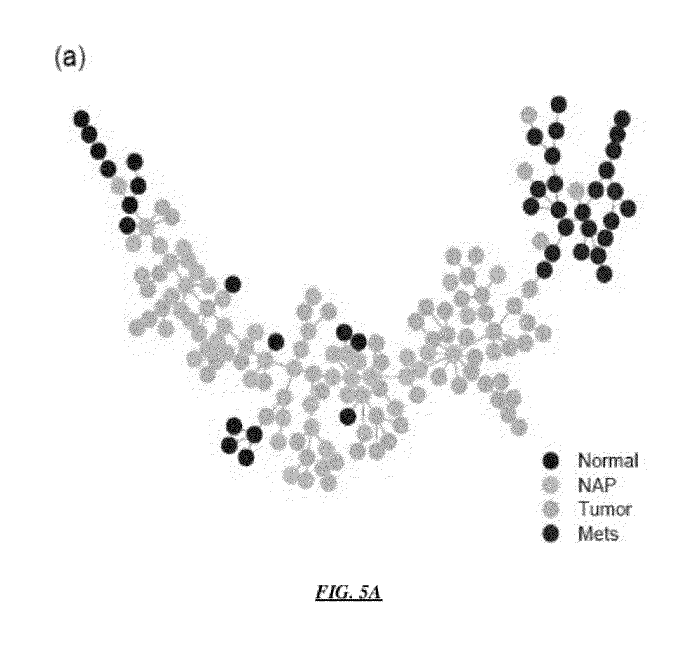

The invention identified 35 feature modules that supported a common progression. This common progression is illustrated in FIG. 4A-B. An encouraging positive result is that the invention ordered the samples perfectly in time, with progressively later stages of differentiating cells radiating outwards from a core cluster of ESC samples, as shown. The outlines shown in the figure are optionally included in the output to highlight each lineage.

In particular displays, nodes are optionally color-coded by the expression level of a gene module (blue means low expression; green/yellow means medium; red means high expression, as would be understood in the art). Module 228, shown in FIG. 4A, was progressively induced in all differentiating lineages, and was enriched for Suz12 and Ezh1 targets. The latter are members of the Polycomb complex that functions in maintaining self-renewal in ESCs. Thus, induction of this module is consistent with a general loss of self-renewal potential in specialized cell types. Module 3, shown in FIG. 4B, enriched by TNF targets, was highly specifically regulated along one lineage, the trophoblast. A subset of induced pluripotent (iPS) cells clustered as a group, in close proximity to ESC samples. Trophoblast stem cells grouped with the trophoblast differentiation lineage, while stromal and fibroblast cell lines were correctly clustered with mature fibroblasts. The modules identified by SPD according to specific embodiments of the invention provided a fine-scale view of expression changes along each lineage. The identified modules included ones which changed in a similar fashion during differentiation of all cell types from ESCs, as well as ones that were uniquely associated with specific lineages. The modules were annotated by comparison to known gene sets, and by examining the relationship between their constituent genes using Ingenuity Pathways Analysis (IPA®) software.

Similarly, modules 54 and 55 (enriched for Myc targets and genes involved in Oct4 maintenance of pluripotency) were both down-regulated in each differentiating branch, but at differing rates with respect to each other, with the strongest muting of expression occurring along the trophoblast lineage. One module (329) was highly enriched for genes that share a common pattern of histone H3K27 methylation, and that are targets of the Ezh2/Polycomb 6 complex. Notably these genes were progressively down-regulated in all branches except the neural lineage. This suggests particular subsets of Polycomb targets that are regulated in a tissue-specific manner.

In the opposite direction, module 65 genes were strongly induced in trophoblast differentiation, and more modestly in the other branches. This module contained numerous genes that are induced by shRNA knockdown of the pluripotency factor Sox2, as well as apoptosis-related genes. Intriguingly, this module included many genes involved in integrin signaling and endocytosis signaling. Thus its strong induction in differentiating trophoblasts (which are involved in placental implantation of the embryo) is consistent with their critical invasive properties, and the SPD result identifies genes that may be implicated in this phenotype.

Two modules (3 and 123) were highly specifically regulated along the trophoblast differentiation branch. WA analysis of module 3 indicated that this cluster of genes was highly enriched with targets of tumor necrosis factor (TNF). This is concordant with the fact that over-expression of TNFa induces differentiation of ESC to trophoblasts. In the dataset analyzed with SPD, trophoblast differentiation was induced by down-regulation of Oct4. The overlap with TNF targets suggests that these two mechanisms of induction share commonalities in the gene expression changes involved in generation of trophoblasts from ESC. Given the master-regulatory role of Oct4 in maintaining pluripotency, one hypothesis is that induction of TNF effects downstream changes in the Oct4 network, while at the same time producing changes in transcription that lead specifically to production of trophoblasts.

Module 123 was annotated as associated with cell motility genes. Again, this is consistent with the invasive character of trophoblasts, and suggests genes that are involved in mediating this behavior. In summary, SPD perfectly recapitulates the lineages leading to differentiated cell types generated by targeted manipulations of ESCs. The differentiation landscape identified by SPD according to specific embodiments of the invention shows underlying progressive changes in gene expression that represent both generic processes as well as ones specific to particular lineages. The genes that constitute the modules supporting the differentiation tree represent targets for further investigation as to their role in organism development.

Note that in this example, the invention provides further information in its output by color coding the nodes according to the expression levels of selected modules. This allows module expression levels to be easily compared against one another and as those modules relate to the progression. With this color coding, the invention can, in one analysis and compactly, determine and output (1) the overall progression of samples, (2) distinct groups of samples in the progression, (3) features and feature modules that are important to the progression, and (4) how expression levels for one or more selected feature modules, or for individual features, vary in the progression.

### Example 4

### Stages of Prostate Cancer Progression

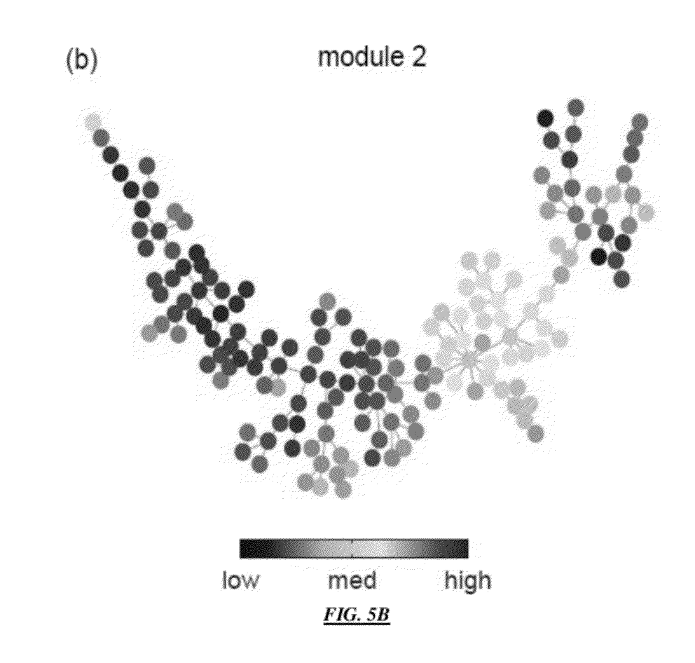

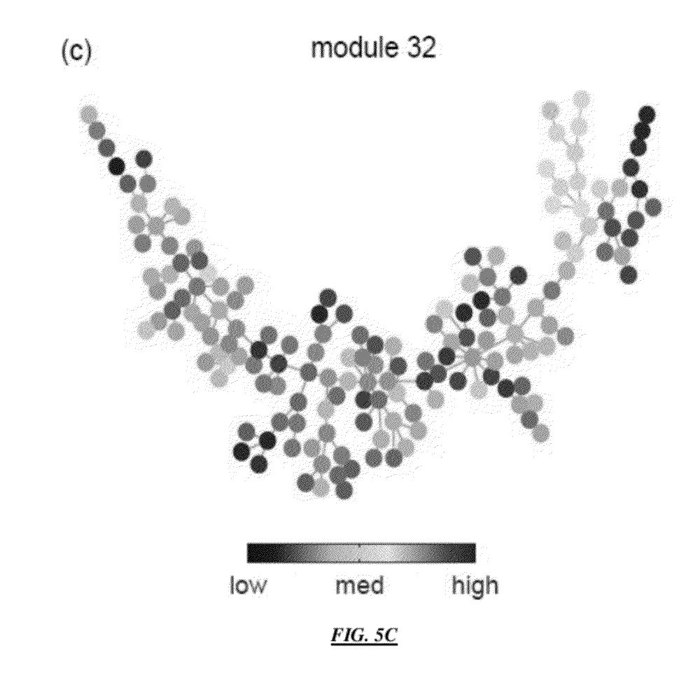

In another example embodiment, the invention was applied to features detected by microarrays from prostate cancer tissues [23]. This dataset contains 163 patient samples, including tissue of normal prostate from organ donors, normal prostate tissue adjacent to the prostate tumor (NAP), primary prostate tumor samples, and metastatic samples. When the invention was applied to this dataset, the clinical information on the samples was hidden. In this dataset, the average correlation between genes was small, consequently, SPD generated modules that contained a small number of genes. Modules that contained less than 5 genes were excluded in the example, leaving 46 coherent modules for subsequent analysis. SPD selected 12 modules (487 genes in total) with high progression similarity and derived the tree structure shown in FIG. 5(a). In FIG. 5(a), the tree was color-coded after the analysis of the invention was completed in order to indicate the ground-truth clinical information of the samples that was hidden from the invention analysis.

Note that this tree represents a more general picture of progression from normal to metastatic cells. The progression determined by the invention shows normal samples enriched at the left side of the progression and metastatic (Mets) samples enriched at the right ends of the tree. The invention also placed a mixture of normal adjacent to prostate tumor (NAP) and tumor samples in the middle of the tree. A larger fraction of NAP samples were closer to normal samples, and tumor samples were closer to the metastatic samples. The mix of NAP and tumor samples reflects possible field effect [23], which suggested that normal tissue adjacent to primary tumor is more similar to the primary tumor than it is to normal tissues. Thus, the invention provides a way to analyze and display a number of samples (such as from 163 patients) that both preserves distinct characteristics of the samples and also shows the overall common progression path from normal to NAP to tumor to metastatic.

To provide further understanding of the data, the invention according to specific embodiments can display color coding of the overall resulting progression tree using the gene expressions of one or more modules of interest. In this example, a color coded tree was produced for each of the 12 modules. This revealed three expression patterns across the tree. Modules that are representative of the three patterns are shown in FIG. 5(b), (c) and (d). As shown in FIG. 5(b), module 2 (and three other modules) are gradually down-regulated from normal to tumor and metastatic samples. As shown in FIG. 5(c), Module 32 (and two other modules) are gradually up-regulated. Interestingly, as shown in FIG. 5(d), the expression of module 19 and 4 other modules first increase from normal to tumor and then gradually decrease in metastatic samples. Another interesting observation is that several modules show clear difference between the two branches in the upper right corner, e.g. FIG. 5(c), (d). This observation indicates that the metastatic samples can be further divided into two subtypes. Thus combining the tree output of the invention with color coding of the feature modules determined by the invention can elucidate further information about the samples.

Gene Set Enrichment Analysis was used to annotate the modules that are up-regulated in primary tumor while down-regulated in both normal and metastatic samples. It can be seen that these modules overlapped with genes involved in metastasis in several epithelial cancers (not just prostate studies). They may reflect general processes underlying the epithelial-mesenchymal transition and cell migration. Of note, one of the genes in this module is CDH3, a member of the cadherin family that interacts with CDH1. Targeted down-regulation of cadherins by RNA interference has been demonstrated to induce cell migration. However, up-regulation from normal to primary tumors followed by down-regulation in metastases has not been commented upon previously.

IPA was applied to the genes that comprised these modules. The most significant interaction network centered around genes involved in androgen and estrogen signaling, and influenced by beta-estradiol. Although estradiol is the predominant sex hormone in females, it is also produced in males as a metabolic product of testosterone. Androgen signaling generally has a pro-survival effect in prostate cancers. Thus, one possible interpretation of the SPD result is that it reflects the fact that in primary tumors, androgen signaling up-regulation confers a selective advantage in the natural history of the tumor; but that some metastases develop androgen-independence. A priori, from gene expression profiles, it is unknown which metastases are androgen-independent; hence, the invention may be identifying both androgen-independent samples, together with the genes whose changes in expression drive the phenomenon.

### Other Embodiments

The clustering step in the present invention can be replaced by a variety of clustering algorithms, such as k-means, hierarchical clustering, mixture models, affinity prorogation, etc. The bottom line is that, a clustering algorithm is need to group together cells that are similar to each other.

The distance metric used in the MST construction and subsequent statistical comparison is the Euclidean distance. The Euclidean distance can be replace by other well defined distance metrics, such as L-1 distance, L-infinite distance, correlation, mutual information, etc. Different choices of the distance metric will lead to different identified progression tree among the sample. From our experience, the Euclidean distance works well for multiple datasets we have tested.

The statistical comparison between the markers via MSTs is a novel method for evaluating similarities. This novel similarity measure enables the automatic identification of progression relevant markers.

### Embodiment in a Programmed Information Appliance

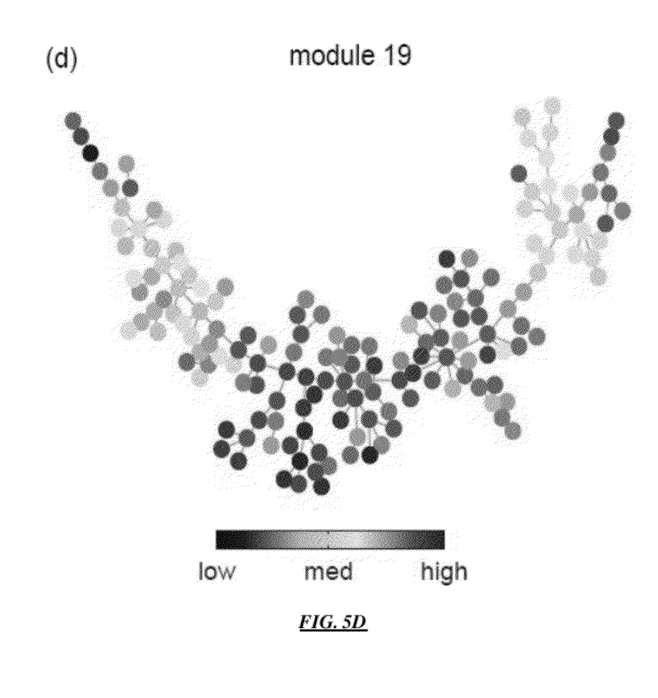

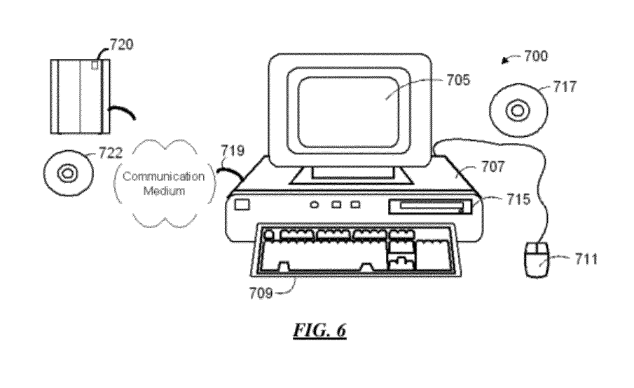

FIG. 6 is a block diagram showing a representative example logic device in which various aspects of the present invention may be embodied. As will be understood from the teachings provided herein, the invention can be implemented in hardware and/or software. In some embodiments, different aspects of the invention can be implemented in separate systems. For example, data collection, validation and storage may take place in one system. Data analysis may take place in a different system. Output and display may be performed by a third system. Moreover, the invention or components thereof may be embodied in a fixed media program component containing logic instructions and/or data that when loaded into an appropriately configured computing device cause that device to perform according to the invention. A fixed media containing logic instructions may be delivered to a user on a fixed media for physically loading into a viewer's computer or a fixed media containing logic instructions may reside on a remote server that a viewer accesses through a communication medium in order to download data or a program component.

FIG. 6 shows an information appliance or digital device 700 that may be understood as a logical apparatus that can perform method steps as described herein and provide visual or audio or printed output of the analysis as described and illustrated herein and/or transmit signals or data to other equipment as understood in the art and described herein. Such a device can be embodied as a general purpose computer system or workstation running logical instructions to perform according to specific embodiments of the present invention. Such a device can also be custom and/or specialized laboratory or scientific hardware that integrates logic processing into a machine for performing various sample handling and data capture operations. In general, the logic processing components of a device according to specific embodiments of the present invention is able to read instructions from media 717 and/or network port 719, which can optionally be connected to server 720 having fixed media 722. Apparatus 700 can thereafter use those instructions to direct actions or perform analysis as understood in the art and described herein. One type of logical apparatus that may embody the invention is a computer system as illustrated in 700, containing CPU 707, optional input devices 709 and 711, storage media (such as disk drives) 715 and optional presentation or display device 705, which can represent any type of device for presenting visual output and can include speakers for presenting audio output, as will be understood in the art. Fixed media 717, or fixed media 722 over port 719, may be used to program such a system and may represent a disk-type optical or magnetic media, magnetic tape, solid state dynamic or static memory, etc. The invention may also be embodied in whole or in part as software recorded on a fixed tangible media, such as a disk drive, ROM, or other storage device. Communication port 719 may also be used to initially receive instructions that are used to program such a system and may represent any type of communication connection.

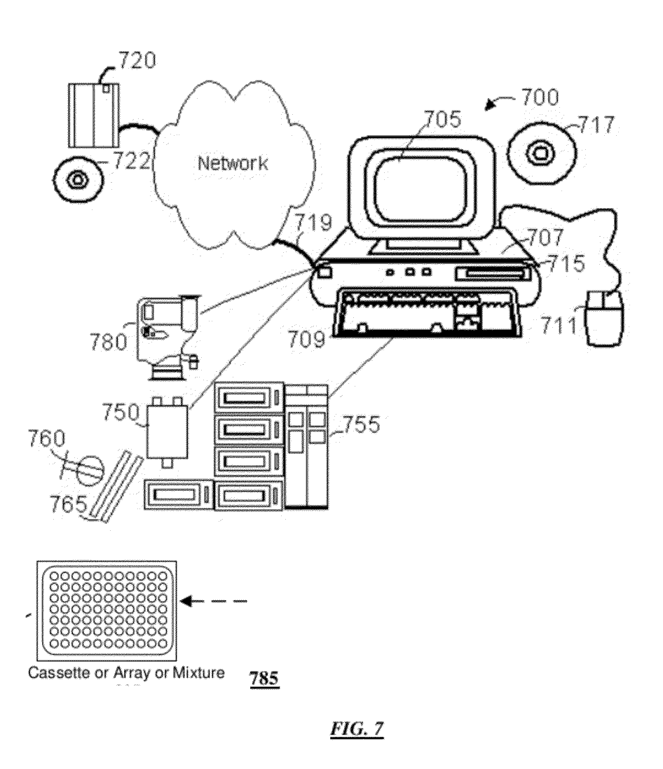

FIG. 7 shows additional components that can be part of a diagnostic system in some embodiments. These components include a microscope or viewer or detector 750, sampling handling 755, light source 760 and filters 765, and a CCD camera or capture device 780 for capturing digital images that may represent feature expression levels from a microarray via luminance detection, such as from microarray 785. It will be understood to those of skill in the art that these additional components can be components of a single system that includes logic analysis and/or control. These devices also may be essentially stand-alone devices that are in digital communication with an information appliance such as 700 via a network, bus, wireless communication, etc., as will be understood in the art. It will be understood that components of such a system can have any convenient physical configuration and/or appearance and can all be combined into a single integrated system. Thus, the individual components shown in FIG. 7 represent just one example system.

The invention also may be embodied in whole or in part within the circuitry of an application specific integrated circuit (ASIC) or a programmable logic device (PLD). In such a case, the invention may be embodied in a computer understandable descriptor language recorded on a tangible digital media, which may be used to create an ASIC, or PLD that in a logic system performs method steps as herein described.

### Other Embodiments

The invention has now been described with reference to specific embodiments. Other embodiments will be apparent to those of skill in the art. In particular, a digital information appliance has generally been illustrated as a personal computer or laboratory workstation. However, the digital computing device is meant to be any information appliance suitable for performing the logic methods of the invention, and could include such devices as a digitally enabled laboratory systems or equipment, digitally enabled televisions, cell phone, personal digital assistant, etc. Modification within the spirit of the invention will be apparent to those skilled in the art. In addition, various different actions can be used to effect interactions with a system according to specific embodiments of the present invention. For example, a voice command may be spoken by an operator, a key may be depressed by an operator, a button on a client-side scientific device may be depressed by an operator, or selection using any pointing device may be effected by the user.

It is understood that the examples and embodiments described herein are for illustrative purposes and that various modifications or changes in light thereof will be suggested by the teachings herein to persons skilled in the art and are to be included within the spirit and purview of this application and scope of the claims. All publications, patents, and patent applications cited herein or filed with this application, including any references filed as part of an Information Disclosure Statement, are incorporated by reference in their entirety.

Although only a few embodiments have been disclosed in detail above, other embodiments are possible and the inventor intends these to be encompassed within this specification. The specification describes specific examples to accomplish a more general goal that may be accomplished in another way. This disclosure is intended to be exemplary, and the claims are intended to cover any modification or alternative that might be predictable to a person having ordinary skill in the art. For example, while microarrays are described in the embodiments, other embodiments may use other kinds of readout. Moreover, as described herein, the output trees are visualization tools, and the computer techniques described herein need not actually make any kind of scatter plot.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be an Intel (e.g., Pentium or Core 2 duo) or AMD based computer, running Windows XP or Linux, or may be a Macintosh computer. The computer may also be a handheld computer, such as a PDA, cellphone, or laptop.

The programs may be written in C or Python, or Java, Brew or any other programming language. The programs may be resident on a storage medium, e.g., magnetic or optical, e.g. the computer hard drive, a removable disk or media such as a memory stick or SD media, wired or wireless network based or Bluetooth based Network Attached Storage (NAS), or other removable medium, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned or can be understood from the teachings herein to those of skill in the art. Where a specified logical sense is used, the opposite logical sense is also intended to be encompassed.

1. A method for determining sample progression from features, wherein samples are characterized by a number of measured or otherwise determined features, the method comprising:
(1) clustering features (e.g., genes) into a smaller number of feature modules, where modules are determined by comparing features across multiple samples;
(2) determining per-module progressions for each selected module;
(3) identifying progression-similar feature modules, by identifying which feature modules have high progression similarity to multiple per-module progressions; and
(4) using the progression-concordant feature modules to determine a most likely overall progression.
(5) outputting said overall progression to a user.

2. (canceled)

3. The method of claim 1 further wherein:
the clustering comprises an iterative agglomerative clustering algorithm; and
the determining a plurality of module progressions uses more than one feature module and comprises using minimum spanning trees to connect the clusters.

4. The method of claim 1 further wherein the samples and features are selected from the group comprising:
the samples are derived from cells in varying stages of a lifecycle or cellular transformation and the features associated with each sample comprise gene markers detected using a microarray;
the samples are derived from cells in varying stages of progression of a cellular malignancy; the features associated with each sample comprise detected genetic or chromosomal anomalies; and the progressive structure comprises one or more graphs showing the progression of a cell from a earlier stage to a later stage of one or more cellular malignancies;
the samples are microarray data readings on tissue samples, the features associated with each sample comprise detected characteristics from particular microarray locations.
the samples are patients in varying stages of progression of a disease or condition and the features associated with each sample comprise patient data including data from one or more diagnostic tests and the progressive structure comprises one or more graphs showing the progression of a patient from a earlier stage to a later stage of one or more diseases or conditions;
the samples are human subjects in varying stages of progression of one or more life stages, experiences, attitudes, or other attributes and the features associated with each sample comprise survey or other statistical data and the progressive structure comprises one or more graphs showing the progression of a human subject from an earlier stage to a later stage of one or more life stages, experiences, attitudes, or other attributes;
the samples are stocks or other business entity, such as futures, commodities, or companies, the features associated with each sample comprise financial or other data related to the business object, and the progressive structure comprises one or more graphs showing progression or differentiation of the samples.

5-9. (canceled)

10. The method of claim 1 further wherein the clustering comprises:
an iterative consensus k-means algorithm to derive consistent coherent modules comprising an iterative divisive hierarchical clustering procedure wherein in every iteration, each module from the previous iteration that has not reached a stopping criteria is divided into two modules, until an overall stopping criterion is met.

11. The method of claim 10 further wherein the clustering comprises:
performing a k-means algorithm L times, with random initialization, to cluster the N samples into k=2 clusters;
arranging clustering results into an N by L matrix, where the (i;j) element is the cluster assignment of gene i in the jth run of k-means;
determining the consensus of the L runs of k-means by applying k-means again based on the N by L matrix, the collection of clustering results of the L runs, to divide genes into two clusters;
for each of the two clusters, computing a cluster coherence as the average Pearson correlation between each gene in the cluster and the cluster center;
if the coherence of a cluster is higher then a pre-specified threshold, label the cluster a coherent module;
otherwise further partition the cluster by iterating the algorithm, with a matrix where N is equal to the number of features in the new cluster; and
after the iterative process ends and all features are assigned to a module, examine the resulting coherent modules pairwisely and if the Pearson correlation of two modules' centers is higher than a pre-specified merge threshold, merge the two modules.

12. (canceled)

13. The method of claim 1 further wherein the progression can contain one or more branchpoints and can contain multiple differentiation paths.

14. The method of claim 1 further comprising outputting features that are key candidate regulators of the underlying process.

15. The method of claim 1 further wherein the determining comprises:
defining a fully connected undirected weighted graph wherein each node represents one sample;
determining a weight on the edge that connects nodes i and j is defined as the Euclidean distance between the feature expressions of samples i and j;
applying Boruvka's algorithm to derive the MST from the fully connected graph;
wherein since the MST connects all the nodes using minimum total edge weights, it tends to connect samples that are more similar to each other;
such that starting from one sample and moving along the edges of the MST, a gradual change of feature expression is observed. and further wherein the determining of progression similarity between modules and trees comprises a comparison between modules and trees constructed from other modules, further comprising:
given the expression data of a feature module x in M samples, define an M by M distance matrix D for each module;
where Dij is the Euclidean distance between the features of samples i and j; and
define an M by M adjacency matrix A of each per-module tree, where Aij=1 if samples i and j are directly connected in that tree and otherwise Aij=0;
determining the p-value of s, by randomly permuting the columns of the expression data, wherein the p-value is the probability of obtaining a smaller s during random permutations and further wherein the permutation value is selected in accordance with the size of the datasets.

16-19. (canceled)

20. The method of claim 1 further wherein the selecting modules that support common progressions comprises:
evaluating statistical concordance between all the modules and all the MSTs wherein if a module is concordant with the MST derived from another module, the two modules are similar in the sense that they support a common progression pattern.

21. (canceled)

22. The method of claim 20 further comprising:
determining a progression similarity between two or more feature modules indicating the number of progressions supported in common by the modules;
wherein the progression similarity is an integer count of progression concordant with the module according to a selected threshold;
further wherein the progression similarity may include weighting factors or non-integer values to indicate more varying degrees of similarity;
further wherein the progression similarity matrix quantifies the progression similarity between pairs of modules, wherein the (u;v) element of the progression similarity matrix is the number of MSTs that are concordant with both modules u and v.

23-24. (canceled)

25. The method of claim 20 further wherein for visualization, the progression similarity matrix is re-ordered by hierarchical clustering of the columns to more easily identify similar modules along the diagonal and further comprising using visual inspection for threshold detection to determine a desired diagonal in the progression similarity matrix.

26-30. (canceled)

31. A computer program product comprising a computer readable medium having one or more logic instructions that when loaded into an appropriately configured system embodies claim 34, wherein said computer readable medium comprises one or more of: a CD-ROM, a floppy disk, a tape, a flash memory device or component, a system memory device or component, a local or network accessible hard drive.

32-33. (canceled)

34. A system containing logic routines for determining sample progression from features, wherein samples are characterized by a number of measured or otherwise determined features, the system comprising:
(1) a software application or logic module for clustering features (e.g., genes) into a smaller number of feature modules, where modules are determined by comparing features across multiple samples;
(2) a software application or logic module for determining per-module progressions for each selected module;
(3) a software application or logic module for identifying progression-similar feature modules, by identifying which feature modules have high progression similarity to multiple per-module progressions; and
(4) a software application or logic module for using the progression-concordant feature modules to determine a most likely overall progression.
(5) a software application or logic module for outputting the overall progression to a user or other logic system.

35-36. (canceled)

37. The system of claim 34 further wherein the samples are selected from the group consisting of:
the samples are derived from cells in varying stages of a lifecycle or cellular transformation and the features associated with each sample comprise gene markers detected using a microarray;
the samples are derived from cells in varying stages of progression of a cellular malignancy and the features associated with each sample comprise detected genetic or chromosomal anomalies and the progressive structure comprises one or more graphs showing the progression of a cell from a earlier stage to a later stage of one or more cellular malignancies;
the samples are microarray data readings on tissue samples and the features associated with each sample comprise detected characteristics from particular microarray locations;
the samples are patients in varying stages of progression of a disease or condition and the features associated with each sample comprise patient data including data from one or more diagnostic tests and the progressive structure comprises one or more graphs showing the progression of a patient from a earlier stage to a later stage of one or more diseases or conditions;
the samples are human subjects in varying stages of progression of one or more life stages, experiences, attitudes, or other attributes and the features associated with each sample comprise survey or other statistical data and the progressive structure comprises one or more graphs showing the progression of a human subject from an earlier stage to a later stage of one or more life stages, experiences, attitudes, or other attributes.
the samples are stocks or other business entity, such as futures, commodities, or companies and the features associated with each sample comprise financial or other data related to the business object and the progressive structure comprises one or more graphs showing progression or differentiation of the samples.

38-42. (canceled)

43. The device of claim 34 further wherein the clustering comprises:
an iterative consensus k-means algorithm to derive consistent coherent modules comprising an iterative divisive hierarchical clustering procedure wherein in every iteration, each module from the previous iteration that has not reached a stopping criteria is divided into two modules, until an overall stopping criterion is met.

44. The device of claim 43 further wherein the clustering comprises:
performing a k-means algorithm L times, with random initialization, to cluster the N samples into k=2 clusters;
arranging clustering results into an N by L matrix, where the (i;j) element is the cluster assignment of gene i in the jth run of k-means;
determining the consensus of the L runs of k-means by applying k-means again based on the N by L matrix, the collection of clustering results of the L runs, to divide genes into two clusters;
for each of the two clusters, computing a cluster coherence as the average Pearson correlation between each gene in the cluster and the cluster center;
if the coherence of a cluster is higher then a pre-specified threshold, label the cluster a coherent module;
otherwise further partition the cluster by iterating the algorithm, with a matrix where N is equal to the number of features in the new cluster; and
after the iterative process ends and all features are assigned to a module, examine the resulting coherent modules pairwisely and if the Pearson correlation of two modules' centers is higher than a pre-specified merge threshold, merge the two modules.

45. The device of claim 34 further wherein the samples are from two or more distinct groups and the method identifies an underlying progression among individual samples both within and across sample groups and wherein the progression can contain one or more branchpoints and can contain multiple differentiation paths.

46. (canceled)

47. The device of claim 34 further comprising outputting features that are key candidate regulators of the underlying process.

48. The device of claim 34 further comprising wherein the determining comprises:
defining a fully connected undirected weighted graph wherein each node represents one sample;
determining a weight on the edge that connects nodes i and j is defined as the Euclidean distance between the feature expressions of samples i and j;
applying Boruvka's algorithm to derive the MST from the fully connected graph;
wherein since the MST connects all the nodes using minimum total edge weights, it tends to connect samples that are more similar to each other;
such that starting from one sample and moving along the edges of the MST, a gradual change of feature expression is observed.

49. The device of claim 34 further comprising wherein the determining of progression similarity between modules and trees comprises a comparison between modules and trees constructed from other modules, further comprising:
given the expression data of a feature module x in M samples, define an M by M distance matrix D for each module;
where Dij is the Euclidean distance between the features of samples i and j; and
define an M by M adjacency matrix A of each per-module tree, where Aij=1 if samples i and j are directly connected in that tree and otherwise Aij=0.

50. The device of claim 34 further comprising:
wherein the selecting modules that support common progressions comprises evaluating statistical concordance between all the modules and all the MSTs;
determining a progression similarity between two or more feature modules indicating the number of progressions supported in common by the modules;
wherein the progression similarity is an integer count of progression concordant with the module according to a selected threshold.

51-52. (canceled)

53. The device of claim 50 further comprising wherein the progression similarity may include weighting factors or non-integer values to indicate more varying degrees of similarity.

54. The device of claim 50 further comprising wherein the progression similarity matrix quantifies the progression similarity between pairs of modules, wherein the (u;v) element of the progression similarity matrix is the number of MSTs that are concordant with both modules u and v.

55. The device of claim 50 further comprising:
wherein for visualization, the progression similarity matrix is re-ordered by hierarchical clustering of the columns to more easily identify similar modules along the diagonal and wherein if there is a diagonal block whose entries all have relatively high values, the corresponding modules indicated similar because they describe a common progression; and
further comprising using visual inspection for threshold detection to determine a desired diagonal in the progression similarity matrix or using an automated threshold detection or edge detection or boundary techniques to determine a desired diagonal in the progression similarity matrix.

56-58. (canceled)
